(19) United States
(12) Patent Application Publication
(10) Pub. No.: US 2010/0310195 A1
(43) Pub. Date: Dec. 9, 2010

(54) LAYERED BAG WITH RE-SEALABLE CLOSURE ASSEMBLY

(75) Inventors: Roger Dale Miller, St. Louis, MO (US); Greg Joseph Petermeyer, Breese, IL (US)

Correspondence Address: GALLOP, JOHNSON & NEUMAN, L.C., 101 S. HANLEY, SUITE 1600, ST. LOUIS, MO, 63105, US

(73) Assignee: Gateway Packaging Company, Granite City, IL (US)

(21) Appl. No.: 12/478,995

(22) Filed: Jun. 5, 2009

(51) Int. Cl. B65D 33/16; B31B 1/64; B31B 1/90; B31B 1/00; B65D 30/08; B65D 30/20

(52) U.S. Cl. 383/63; 493/199; 493/214; 493/267; 383/116; 383/120

(57) ABSTRACT

A multi-layered bag with a re-sealable closure assembly attached thereto is provided, as well as a method of manufacturing the same. Specifically, multi-layered paper composite bags with a re-sealable closure assembly attached to the innermost layer of the bag as well as a method of manufacturing the same are provided. A slider-operated zipper is a particularly preferred embodiment of a re-sealable closure assembly. The bags may be gusseted and comprise an outer paper layer, a middle paper layer and an inner plastic film or sheet layer, and the bottom of the bag may be open bottomed or close bottomed.

### BACKGROUND OF THE INVENTION

The present invention relates generally to multi-layered bags with a re-sealable closure assembly attached thereto as well as a method of manufacturing the same, and more specifically to multi-layered paper composite bags with a re-sealable closure assembly attached to the innermost layer of the bag as well as a method of manufacturing the same.

In the field of bag manufacturing, particularly multi-layered bags that comprise one or more layers of a paper material, it is known in the art to have a re-sealable closure assembly attached to the bag during manufacture. However, the prior art is limited in that re-sealable closure assemblies are typically affixed to the outermost layer of such a bag.

Attachment of the re-sealable closure assembly to the outermost layer of the bag poses several problems. For example, conventionally, a re-sealable closure assembly on the outermost layer of a multi-layered paper bag is affixed with a material such as a hot glue melt, increasing cost and eventual waste. Additionally, a hot glue melt or similar material generally provides a comparably less efficient seal than does a seal created by adhering the re-sealable closure assembly directly to a compatible material, such as a polyethylene layer. Further, a re-sealable closure assembly on the outermost layer of a bag typically extends beyond the side edges of the bag, resulting in excess lengths of re-sealable closure assembly material per bag that are multiplied over millions of mass-produced bags, thereby increasing cost and eventual waste. Also, as will be explained in more detail below, a re-sealable closure assembly affixed to the outside layer of the bag severely limits tamper-evident seal options and, in particular, makes implementation of such a seal at the base of the assembly problematic. Moreover, a re-sealable closure assembly that has been mounted on the outside of a bag interferes with the appearance of the bag, reducing its aesthetics and the area for visible printing on the outside of the bag. These and other problems in the art create a need for a mass-produced, multi-layered paper composite bag with a re-sealable closure assembly that is not affixed to the outside layer of the bag, as well as a pressing need for a method for making the same.

In the field of bag manufacturing it is well-known in the art to have a re-sealable closure assembly attached to the inside of a plastic bag. Plastic bags, however, do not face certain obstacles associated with multi-layered paper composite bags if one were to attempt to equip the multi-layered paper composite bag with re-sealable closure assemblies.

One such obstacle is encountered when the multi-layered paper composite bag is presented to a re-sealable closure assembly attachment machine. When a plastic bag is presented to such a machine, it is as a single ply or layer. Even if the material that that makes up the a plastic bag may be made of multiple plies, those plies were laminated or otherwise adhered to one another to form a single layer prior to the manufacture of the bag or at least prior to the attachment of the re-sealable closure assembly.

Conversely, the layers of a multi-layered paper composite bag remain distinct so as to retain their respective properties. For example, one type of multi-layered paper composite may include an outer clay-coated paper layer, which is intended to readily accept printing, a middle Kraft paper layer, which is intended to provide strength and rigidity to the bag, and an inner barrier layer, such as co-extruded polyethylene or blended polyethylene, which is intended to provide a separation from a food product and the Kraft paper as well as to provide a more effective seal between the elements and the food product. Such a multi-layered paper composite bag, when presented to a re-sealable closure assembly attachment machine, inherently creates complications due to the multiple layer structure. Each of these layers, with independent properties and being only somewhat attached to another layer, may act independently and often unpredictably when manipulated in a horizontal conveyor-type machine, such as a machine used to affix a re-sealable closure assembly. Accordingly, conventionally, these types of bags have been manipulated only minimally if at all in attaching a re-sealable closure assembly on the outermost layer. Effective mechanical manipulation of such a bag on a mass-production scale is critical to affixing a re-sealable closure assembly to the inside of such a bag, something previously not accomplished in the art.

Use of conventional techniques for attaching re-sealable closure assemblies to plastic bags to attach a re-sealable closure assembly to the interior of a multi-layered paper composite bag would also encounter problems associated with heat transfer. With a plastic bag, the heat may be applied effectively to the zipper and bag from the outside of the bag, regardless of whether or not the zipper strip material is located on the inner portion of the bag or the outer portion of the bag. There are two primary reasons that this is possible. First, the plastic that makes up the bag readily transfers the heat through itself to the zipper strip material, due to both the single ply nature of the bag and the high thermal conductivity of the bag material. Second, the plastic that makes up the bag may itself at least partially melt alongside the zipper strip material, allowing both to cool together to form an effective seal.

Conversely, multi-layer paper composites are relatively poor thermal conductors, so if the bag is constructed of a multi-layered paper composite, applying heat to the outside of the bag is less effective, as heat passes poorly through the bag material to the re-sealable closure assembly material. This problem has been addressed in the past by affixing the assembly to the outside of the bag on the clay coated paper layer. However, this attempt to address the heat transfer problem has been unsatisfactory because heat applied to a plastic re-sealable closure assembly material and clay coated paper has not been found to form an effective seal. Thus, it is typical in the art to use a hot glue melt or similar material to bind the two materials together. Moreover, even if the heat transfer problem were solved, there are additional obstacles associated with presenting a multiple layer composite bag to a re-sealable closure assembly attachment machine and the absence in the art of a suitable unfinished bag for use in such a machine remains.

Thus, there is a need in the art for a mass-produced multi-layered paper composite bag with a re-sealable closure assembly that has been attached to the inside or innermost layer of the bag, as well as a need for a method for making the same. Accordingly, the present new, unique and useful invention seeks to overcome these and other existing problems and needs in the art.

### SUMMARY OF THE INVENTION

The present invention is a mass-produced multi-layered bag with a re-sealable closure assembly attached thereto as well as a method of manufacturing the same, and more specifically to multi-layered paper composite bags with a re-sealable closure assembly attached to the innermost layer of the bag as well as a method of manufacturing the same.

A slider-operated zipper is a particularly preferred embodiment of a re-sealable closure assembly for use in the present invention. At the base of the re-sealable closure assembly, it is preferred for a tamper evident membrane to be present.

Bags of the present invention are preferably gusseted multi-layered paper composite bags comprising an outer paper layer, a middle paper layer and an inner plastic film or sheet layer. Preferably the outer paper layer is clay-coated paper, the middle layer is Kraft paper, and the inner plastic film or sheet is co-extruded polyethylene or blended polyethylene. The bottom of the bag may be open bottomed or close bottomed.

Additionally, the present invention additionally includes a product made by the method of making a multi-layered paper composite bag, such as the one detailed herein.

### BRIEF DESCRIPTION OF THE DRAWINGS

FIG. 1 is a perspective view of a first embodiment of the multilayered paper composite bag of the present invention, this figure showing the partially unfolded gussets.

FIG. 2 is a perspective view of the first embodiment, this figure showing the trimming of the top of the bag.

FIG. 3 is a perspective view of the first embodiment, this figure showing the folding of the top ends.

FIG. 4 is a perspective view of the first embodiment, this figure showing the notches on the upper outer portions of the each of the gussets.

FIG. 5 is a perspective view of the first embodiment, this figure showing the second top end, having been re-folded back into alignment with the gussets.

FIG. 6 is a perspective view of the first embodiment, this figure showing the re-sealable closure assembly, having been mounted on the bag and heat sealed to the gussets.

FIG. 7 is a perspective view of the first embodiment, this figure showing the re-sealable closure assembly, having been heat sealed to the gussets and the second top end.

FIG. 8 is a perspective view of the first embodiment, this figure showing the first top end, having been re-folded back into alignment with the gussets and the second top end.

FIG. 9 is a perspective view of the first embodiment, this figure showing the bag having been heat sealed along the outer portions of the gussets and the top ends.

FIG. 10 is a perspective view of a completed first embodiment of the multilayered paper composite bag of the present invention, this figure showing the gussets folded and the bag substantially flat.

FIG. 11 is a perspective view of a second embodiment of the multilayered paper composite bag of the present invention, this figure showing the partially unfolded gussets.

FIG. 12 is a perspective view of the second embodiment, this figure showing the trimming of the top of the bag.

FIG. 13 is a perspective view of the second embodiment, this figure showing the folding of the first top end and the gussets.

FIG. 14 is a perspective view of the second embodiment, this figure showing the re-sealable closure assembly, having been mounted on the second top end and heat sealed to the outer portions thereof.

FIG. 15 is a perspective view of the second embodiment, this figure showing the re-sealable closure assembly, having been heat sealed across the length of the second top end.

FIG. 16 is a perspective view of the second embodiment, this figure showing the first top end and the gussets, having been re-folded back into alignment with the re-sealable closure assembly and second top end.

FIG. 17 is a perspective view of the second embodiment, this figure showing the bag having been heat sealed along the outer portions of the gussets and the top ends.

FIG. 18 is a perspective view of a completed second embodiment of the multilayered paper composite bag of the present invention, this figure showing the gussets folded and the bag substantially flat.

FIG. 19 is a detail top perspective view of one side of a portion of a completed first embodiment of the multilayered paper composite bag of the present invention, this figure showing a tamper-evident seal that has been breached, and further showing the detailed relationship between the top ends, a gusset and the re-sealable closure assembly.

FIG. 20 is a detail top perspective view of a portion of the other side of the completed first embodiment of the multilayered paper composite bag of the present invention, this figure showing a tamper-evident seal that has been breached, and further showing the detailed relationship between the top ends, a gusset and the re-sealable closure assembly, as well as the slider.

FIG. 21 is a detail view of a portion of an unfinished bag, this figure showing details of a slit along the outer layer of the gusset.

FIG. 22 is a detail view of a portion of an unfinished bag, where the bag has undergone a trimming of the top of the bag.

FIG. 23A is a cross-sectional view of a tamper-evident re-sealable closure assembly, such as one that may be mounted inside an embodiment of a closed-bottom bag of the present invention, this figure showing the tamper-evident membrane intact and the re-sealable closure assembly closed, and this particular figure depicting the multi-layer composite material as one layer.

FIG. 23B is a cross-sectional view of a tamper-evident re-sealable closure assembly, such as one that may be mounted inside an embodiment of a closed-bottom bag of the present invention, this figure showing the tamper-evident membrane intact and the re-sealable closure assembly open, and this particular figure depicting the multi-layer composite material as one layer.

FIG. 23C is a cross-sectional view of a tamper-evident re-sealable closure assembly, such as one that may be mounted inside an embodiment of a closed-bottom bag of the present invention, this figure showing the tamper-evident membrane open and the re-sealable closure assembly open, and this particular figure depicting the multi-layer composite material as one layer.

FIG. 24A is a cross-sectional view of a tamper-evident re-sealable closure assembly, such as one that may be mounted inside an embodiment of an open-bottom bag of the present invention, this figure showing the tamper-evident membrane intact and the re-sealable closure assembly closed, and further showing the opening through which bag contents may be inserted, and this particular figure depicting the multi-layer composite material as one layer.

FIG. 24B is a cross-sectional view of a tamper-evident re-sealable closure assembly, such as one that may be mounted inside an embodiment of an open-bottom bag of the present invention, this figure showing the tamper-evident membrane intact and the re-sealable closure assembly closed, and further showing the closure of the opening through which bag contents may be inserted, and this particular figure depicting the multi-layer composite material as one layer.

### DETAILED DESCRIPTION OF THE INVENTION

In a preferred embodiment, the present invention relates to re-sealable closure assemblies that are slider type assemblies, also referred to as a slider-operated zipper. Conventional slider-operated zipper assemblies typically comprise a plastic zipper having two interlocking profiles and a slider for opening and closing the zipper. In one type of slider-operated zipper assembly, the slider straddles the zipper at the top of the assembly and has a separating finger at one end that is inserted between the profiles to force them apart as the slider is moved along the zipper in an opening direction. The other end of the slider is sufficiently narrow to force the profiles into engagement and close the zipper when the slider is moved along the zipper in a closing direction.

At the ends of the profiles, typically some type of structure is present to keep the slider on the zipper. This structure can be an end clip, or a portion of the zipper that has been closed via a heat seal, or any other conventional structure or mechanism known to those of ordinary skill in the art.

At the base of the re-sealable closure assembly, it is common in the art for a tamper evident membrane to be present. This is typically achieved during the initial manufacture of the assembly, where a ribbon of plastic material is bent or otherwise slightly scored at or about the midpoint of the width of the ribbon, where the bend or score runs with the ribbon substantially parallel to the edges of the ribbon. Once folded along the bend or score, the two sides of the re-sealable closure assembly are formed, the distinction between each side defined by the bend or score and the respective edge of the plastic ribbon. Such a tamper evident feature is thus not achievable on a re-sealable closure assembly attached to the outside of a bag, as the two opposing sides of the re-sealable closure assembly do not meet at their respective bases.

The zipper strip material typically comprises one or more types of plastic, where one type of plastic may make up the ribbon portion of the material, and another type of plastic may make up the interlocking profile portions of the material. The compositions of such plastics are typically proprietary information of the company manufacturing the zipper strip material. The preferred qualities of such plastics, however, include the ability to at least partially melt under temperatures from 350 degrees Fahrenheit to 600 degrees Fahrenheit, as well as the ability to cool readily and adhere to a compatible surface. It would be undesirable to have the two distinct ribbons of zipper strip material to seal to one another as the re-sealable closure assembly is affixed to the bag upon application of heat and pressure at the various stations detailed below. Therefore it is highly preferred that the zipper strip material comprise a material that is resistant to being sealed to itself or, alternatively, comprise a material that has been pre-treated by the zipper strip material manufacturer to be resistant to such sealing.

In manufacturing such a slider-operated zipper assembly, typically a zipper strip assembly is spool fed. The slider may be introduced into the zipper assembly at any suitable time, though it is preferably introduced while the zipper assembly is in ribbon form, prior to being fed to the re-sealable closure assembly attachment machine. Similarly, the end clips, when present, are preferably applied while the zipper assembly is in ribbon form, and may be applied at or about the same time as the slider, both prior to being fed to the re-sealable closure assembly attachment machine. In this manner, both the slider and end clips are preferably positioned at predetermined locations on a continuous zipper assembly in ribbon form and fed to the re-sealable closure assembly attachment machine, where the zipper assembly ribbon is cut into segments, such that each segment comprises a single zipper straddling the top of the assembly and two end clips, one each located at or near the approximate ends of the segments. These segments are then preferably individually attached to the multi-layered paper composite bag as further detailed herein.

Re-sealable closure assemblies other than slider type assemblies are embraced within the scope of the present invention, including those re-sealable closure assemblies that include a pair of interlocking profiles, but do not include a slider, and are instead closed by longitudinal-moving finger pressure and opened by simply pulling the two interlocking assemblies apart. These and other re-sealable closure assemblies are suitable for use with a multi-layered paper composite bag of the present invention, and are within the full range and scope of equivalents.

In order for one skilled in the art to manufacture a multi-layered paper composite bag of the present invention, a preferred series of steps will now be detailed. Though one of ordinary skill in the art may amend these steps, including the addition or possible substitution or subtraction of steps, as well as a change in order or other amendments to the process, it should be generally understood that the present invention includes all mass-produced multi-layered paper composite bags with a re-sealable closure assembly attached to the innermost layer of the bag, regardless of the process utilized. The preferred process, however, will now be discussed.

Prior to beginning the preferred machine-driven assembly line type manufacturing process that attaches the spool-fed zipper strip material, where the slider and end clips have been attached thereto prior to reaching the machine, unfinished multi-layer paper composite bags are prepared and loaded into a magazine or other suitable type of holding location or device at or near one end of the machine.

The unfinished bags suitable for use in the present invention comprise a pair of panels of multi-layered composite material, each panel having opposite sides, and opposite top and bottom, the top terminating in a top edge, the top edges being generally parallel to each other. Each of the panels comprises an inner layer, a middle layer, and an outer layer. The panels are interconnected at their sides by gussets of multi-layered composite material bridging the sides to form a gusseted bag, with the inner layer facing inwardly and the outer layers facing outwardly.

The unfinished bags may be of two types, depending on the specifications of the bag customer. One type of bag is the open bottom and the other type of bag is the closed bottom. As further detailed below, the re-sealable closure assembly may be attached to the bag in two primary ways, those being the complete and incomplete attachments. Where an incomplete attachment of the assembly is present, the unfinished bag would be a closed bottom bag, so that the bag customer could fill the food or other product through the top of the bag, between the innermost layer of a first top end of the multi-layered paper bag and the re-sealable closure assembly. Conversely, where a complete attachment of the assembly is present, the unfinished bag would be an open bottomed bag, so that the bag customer could fill the food or other product from the bottom of the bag. In either instance, the bag customer would seal the bag in the respective opening, once the food or other product has been inserted therein, depending on the type of bag that customer receives.

Preferred unfinished bags suitable for use in the present inventive process are gusseted multi-layered paper composite bags comprising an outer paper layer, a middle paper layer and an inner plastic film or sheet layer. In an embodiment, the outer paper layer is clay-coated paper, the middle layer is Kraft paper, and the inner plastic film or sheet is co-extruded polyethylene or a polyethylene blend. In an embodiment, the inner plastic film or sheet layer is low density polyethylene or linear low density polyethylene blended with high density polyethylene, thereof, including a blend that is 3:2 low density polyethylene or linear low density polyethylene to high density polyethylene. In another embodiment, the inner plastic film or sheet layer is a barrier film, where the barrier film is preferably a multilayered co-extruded film comprising a single layer of high density polyethylene between two layers of linear low density polyethylene. In yet another embodiment, the inner plastic film or sheet layer is a barrier film, where the barrier film is preferably a multilayered co-extruded film comprising a single layer of high density polyethylene and a single layer of linear low density polyethylene, where the high density polyethylene face of the film is adjacent to the Kraft paper in a multi-layered paper composite bag. In an embodiment, the middle layer may further comprise multiply ply or sheets of material, including multiple layers of Kraft paper.

As detailed previously herein, the bottom of the unfinished bag may be open bottomed or close bottomed, though, in either event, it is preferred that the bottom of the bag be step cut, and, if close bottomed, that the longest step be folded over the opening so as to completely cover the shortest step, and sealed with a hot glue melt or similar material prior to introducing the bag to the machine. The top of the unfinished bag is open and preferably flush cut, and further both sets of bag folds that define the outer limits of the gussets on each side of the bag have been slit along the fold, each slit substantially identical to the others, and each slit residing just below the flush cut, such that the slit does not extend to the flush cut, but instead terminates a small distance from the flush cut, thereby resulting in each unfinished bag having four separate, substantially identical slits.

In an embodiment, the length of each slit is between 90 mm to 100 mm in length. In this embodiment, the distance between the top end of each slit and the top of the unfinished bag is between 5 mm to 10 mm in length.

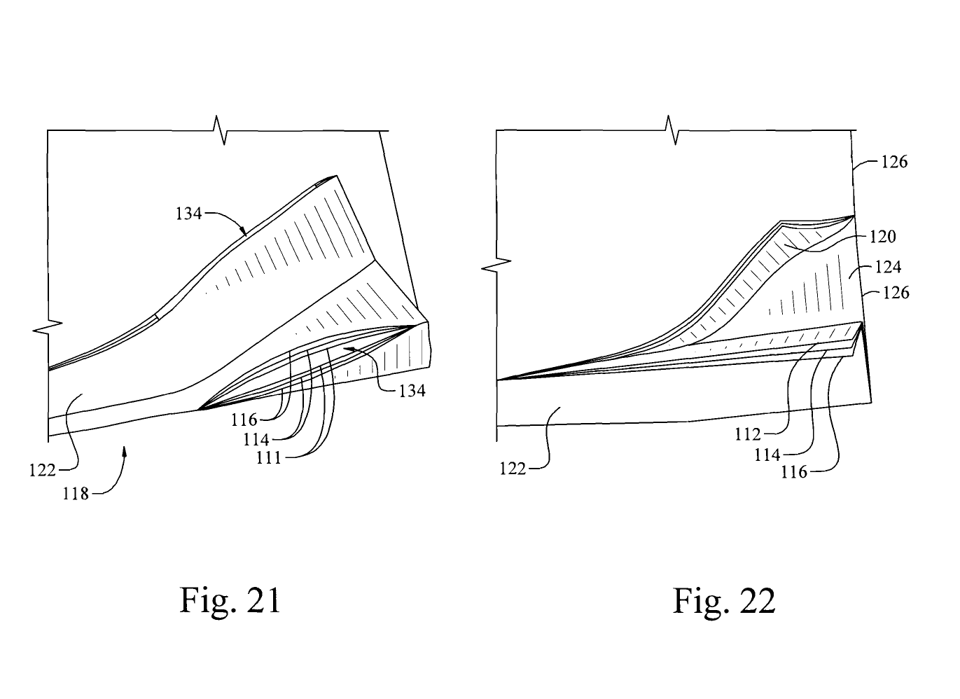

FIG. 21 is a detail view of an unfinished bag, this figure showing a slit 134 along the outer edge 136 of the gusset 122. FIG. 22 is a detail view of a bag, where the bag has undergone a trimming of the top of the bag to remove the top portion of the bag from just below the top of the slits, this trimming thereby creating a first top end 120 and a second top end 124 at the top of the bag 118, and thereby partially separating the first and second top end from the corresponding upper portions of the gussets 122, as further detailed below.

An unfinished bag undergoing the preferred machine-driven assembly line type manufacturing process that attaches the spool-fed zipper strip material to the bag, once taken from the magazine or other suitable type of holding location or device at or near one end of the machine, undergoes a series of mechanical steps at various stations to attach the re-sealable closure assembly to the bag. Spatially, as the bag moves down the assembly line, the majority if not all of the body of the bag remains substantially parallel to a conveyor belt or similar device, which is preferably substantially parallel to the ground. Further, it is preferred that the movement of the bag down the conveyor belt or similar device be substantially linear. As the bag moved down the conveyor belt or similar device, it is preferred that each station be located on a single side of the conveyor belt or similar device.

Preferably, the stations, in sequential order from the magazine or other suitable type of holding location or device to the opposing termination of the conveyor belt or similar device, comprise a bag introduction station, a bag cutting station, a bag opening station, a re-sealable closure assembly feeder station, one or more gusset punch stations, one or more optional gusset hole stations, a re-sealable closure assembly introduction and seal station, a second top end seal station, one or more left seal stations, one or more right seal stations, one or more optional cooling stations, one or more optional excess assembly punch stations, and an optional first top end seal station.

Additionally, it is highly preferred that a control station with a control logic be present so as to permit programming of the individual stations and other components of the machine, such as the conveyor belt or similar device and the magazine or other suitable type of holding location or device.

The bag introduction station non-destructively places the unfinished bag onto the assembly line, preferably onto a conveyor belt or bed or other similar conveyable surface or surfaces, including any number known to those of ordinary skill in the art.

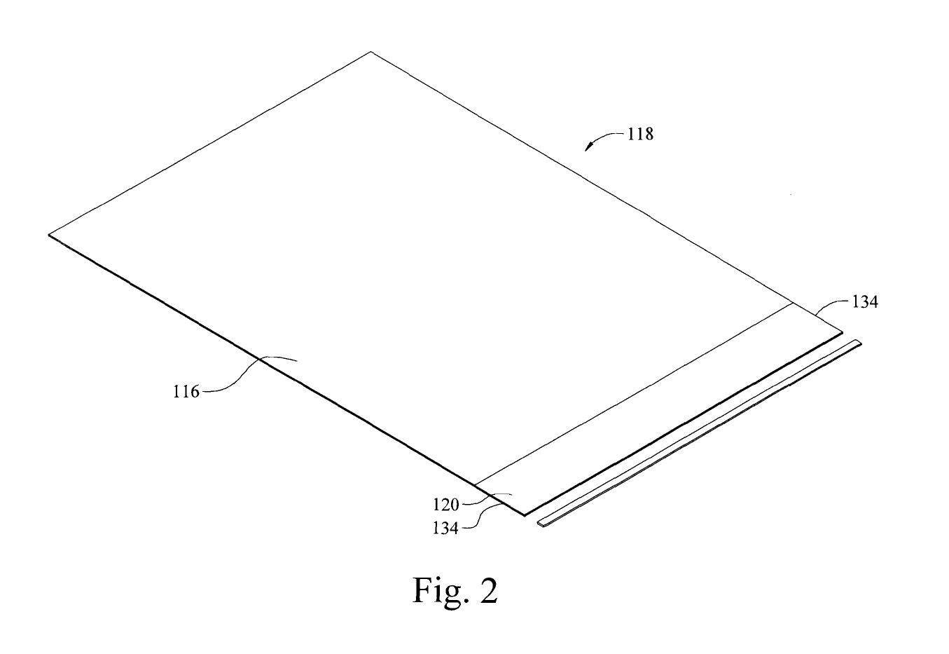

The bag cutting station cuts a strip of multi-layered paper composite material from the top of the bag in a flush cut, this flush cut being sufficient so as to remove the top portion of the bag from just below the top of the slits, this flush cut creating a first top end and a second top end and upper portions of the gussets, and thereby partially separating the front and second top end from the corresponding upper portions of the gussets. FIG. 2 shows a bag that has been trimmed at a bag cutting station.

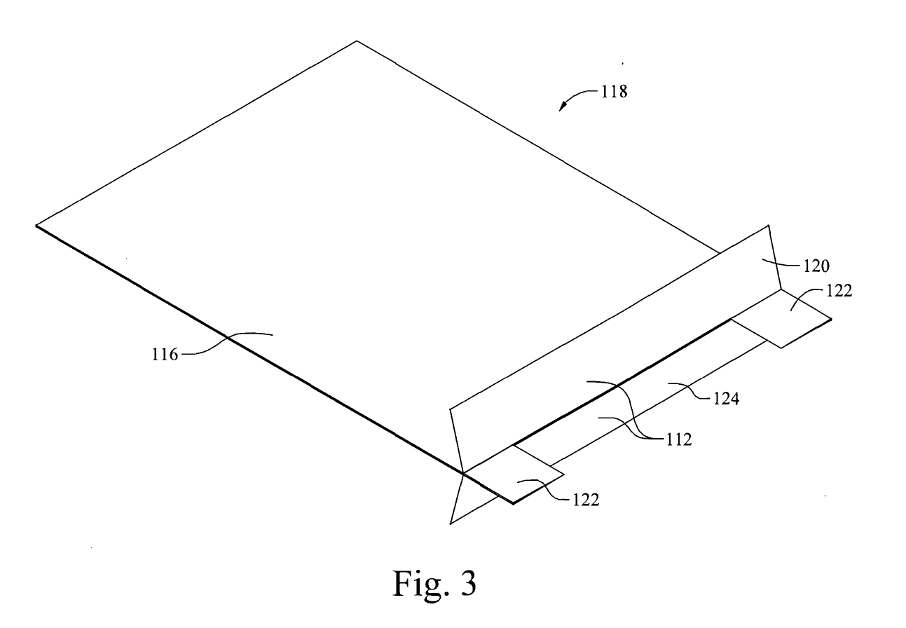

The bag opening station folds the first top end and the second top end, respectively, away from the upper portions of the gussets in a non-destructive manner, preferably through the use of a pair of sets suction cups, thereby exposing the gussets, which remain substantially horizontal with respect to the conveyor belt. FIG. 3 shows a bag that has had its first top end and second top end folded at the bag opening station.

The re-sealable closure assembly feeder station is essentially a spool that receives the continuous zipper assembly in ribbon form, the slider and end clips having been previously attached thereon, and this station feeds the zipper assembly to the re-sealable closure assembly introduction and seal station.

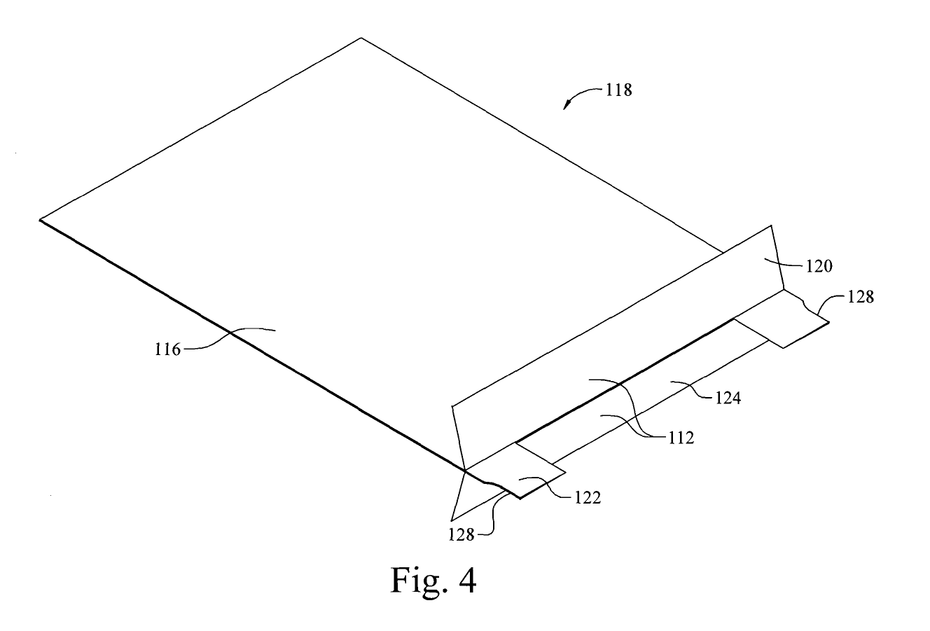

The one or more gusset punch stations cut, preferably in a die punch manner, a portion of the outermost upper edges of the upper portions of the gussets, thereby trimming a notch into each of the gussets. This may be performed by a single station, or preferably by two separate stations in sequence, where each station punches one gusset. FIG. 4 shows a bag that has been cut at one or more gusset punch stations.

One or more optional gusset hole stations may be present, either before or after, or in conjunction with, the gusset punch stations. A gusset hole station punches one or more holes in a gusset, these one or more holes providing increased heat transfer ability and thus improving the attaching the re-sealable closure assembly to the second top end at a later station on the machine.

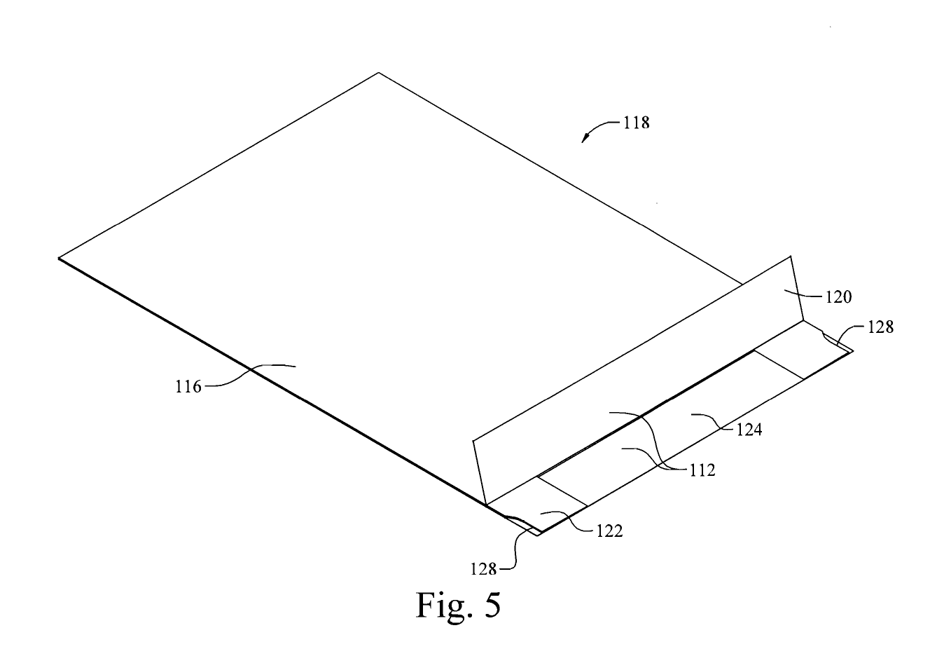

Once the gussets have been cut at the one or more gusset punch stations, and optionally after the one or more gusset hole stations have punched one or more holes in each gusset, the second top end is re-folded back into substantially parallel alignment with the upper portions of the gussets, which can be achieved through any number of mechanical devices known to those of ordinary skill in the art, including a stationary, non-mechanical curved rod positioned so as to non-destructively manipulate the second top end as the bag moves down the assembly line on the conveyor belt. FIG. 5 shows a bag that has had the second top end re-folded back into alignment with the upper portions of the gussets.

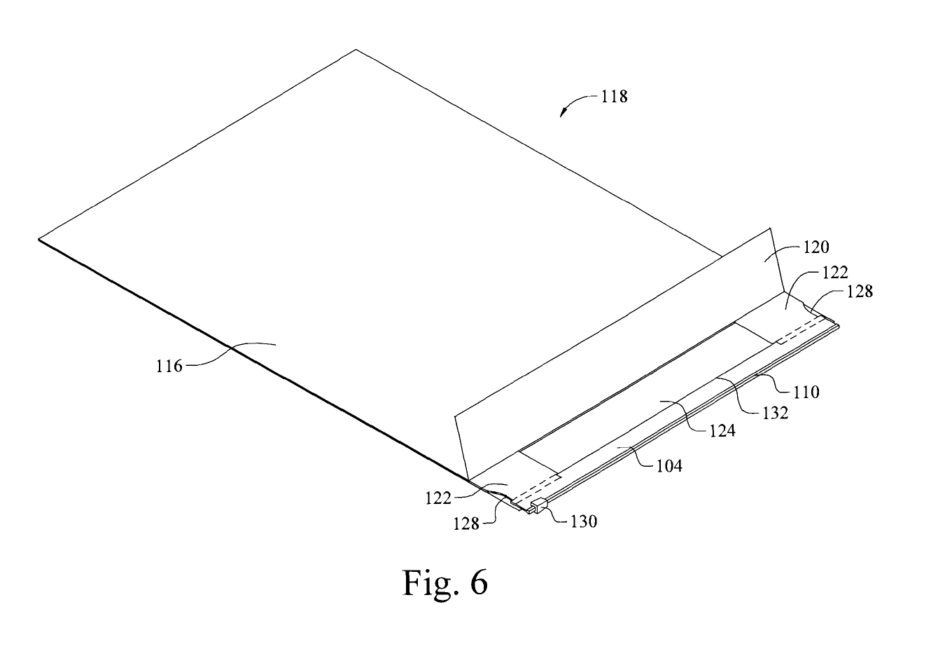

The re-sealable closure assembly introduction and seal station receives the continuous zipper assembly in ribbon form, the slider and end clips having been previously attached thereon, from the re-sealable closure assembly feeder station. The re-sealable closure assembly introduction and seal station then cuts the zipper assembly in ribbon form into single bag re-sealable closure assembly segments, each segment having two end clips, one disposed at or near the outermost edge of each segment, and each segment having a single slider disposed between the two end clips. The re-sealable closure assembly introduction and seal station, for each bag, then introduces a single re-sealable closure assembly to the upper portion of the exposed gussets and second top end, such that the segment is substantially centered between the gussets, and such that the end clips, slider and interlocking profiles reside above the upper edges of the upper portions of the gussets, but a substantial amount of the remainder of the re-sealable closure assembly rests on the upper portion of the gussets and the second top end. Having introduced a single bag re-sealable closure assembly to a bag, the re-sealable closure assembly introduction and seal station then heat seals the segment to each of the upper portions of the gussets, this heat sealing occurring across the width of each gusset, substantially parallel to the length of the re-sealable closure assembly. FIG. 6 shows a bag that has had the re-sealable closure assembly introduced thereto and has further had two heat seals applied, the location of the heat seals shown by dashed lines.

In an embodiment, the area of each heat seal applied at the re-sealable closure assembly introduction and seal station as indicated in FIG. 6 is 60 mm×10 mm. In this embodiment, each heat seal is effectuated through a heat seal clamp, where each clamp has a Teflon coating that covers the surface of the clamp that contacts the bag. In this embodiment, the heat seal clamp may dwell on each bag for a period of between 0.7 seconds to 1.5 seconds, preferably 0.9 seconds. In this embodiment, the heat seal clamp is at a temperature of between 500 degrees Fahrenheit to 600 degrees Fahrenheit, preferably 554 degrees Fahrenheit.

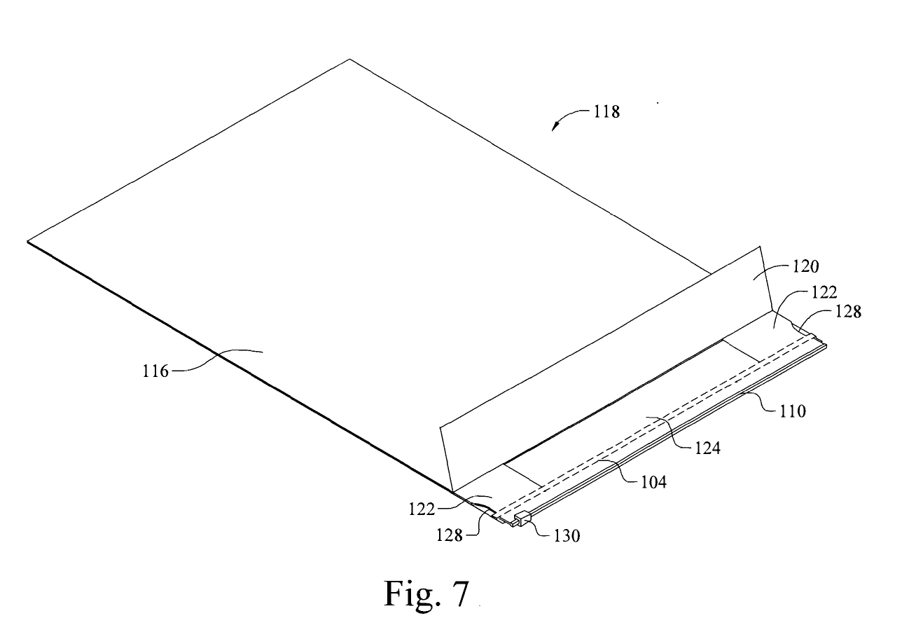

The second top end seal station applies a heat seal across the entire width of the bag, this seal preferably being in substantial alignment with the seals applied at the re-sealable closure assembly introduction and seal station, and this seal serving the dual purpose of sealing the re-sealable closure assembly to the second top end and strengthening the seal between the re-sealable closure assembly and the gussets. FIG. 7 shows a bag that has been sealed at the second top end seal station, the location of the heat seal shown by dashed lines.

In an embodiment, the area of the heat seal applied at the second top end seal station as indicated in FIG. 7 is 510 mm×10 mm. In this embodiment, the heat seal is effectuated through a heat seal bar, where the bar has a Teflon coating that covers the surface of the bar that contacts the bag. In this embodiment, the heat seal bar may dwell on each bag for a period of between 0.7 seconds to 3.0 seconds. In this embodiment, the heat seal clamp is at a temperature of between 400 degrees Fahrenheit to 500 degrees Fahrenheit.

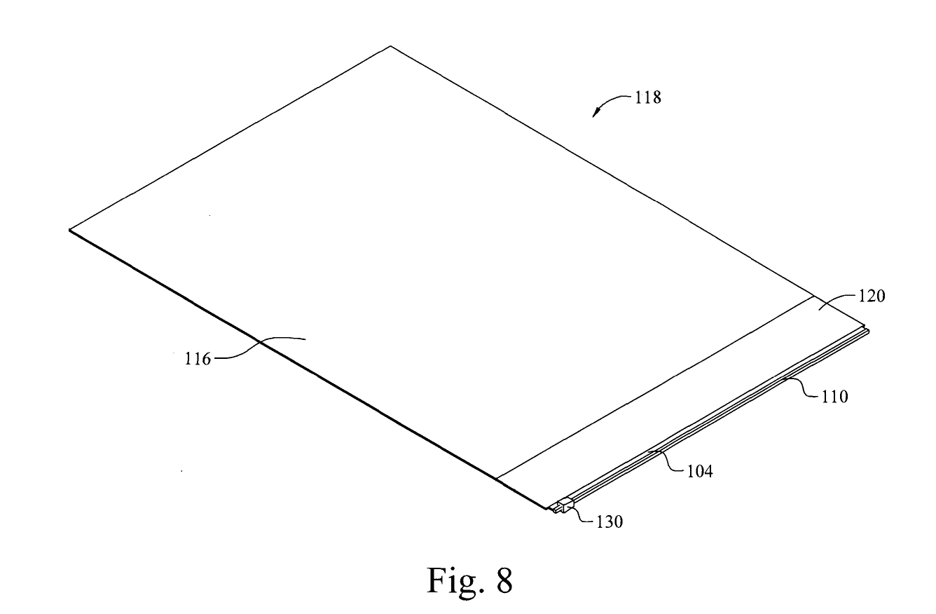

Once the bag has passed the second top end seal station, the first top end is re-folded back into substantially parallel alignment with the remainder of the bag, which can be achieved through any number of mechanical devices known to those of ordinary skill in the art, including a stationary curved rod positioned so as to non-destructively manipulate the first top end as the bag moves down the assembly line on the conveyor belt. FIG. 8 shows a bag that has had the first top end re-folded back into alignment with the remainder of the bag.

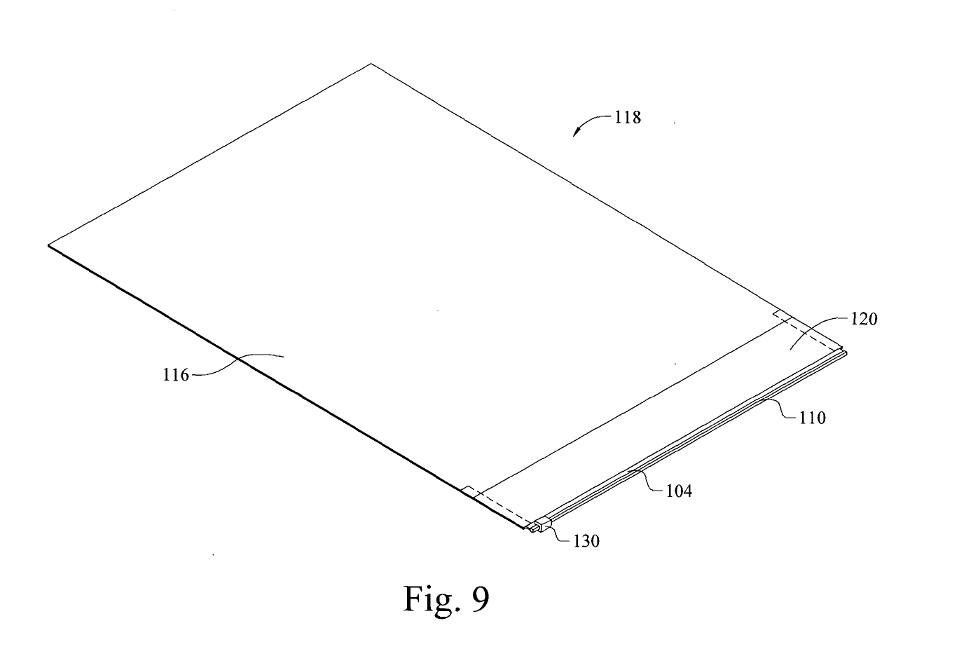

The one or more left seal stations and the one or more right seal stations have similar functions and purposes, the distinctions between the right seal station and the left seal station being the side of the bag that the respective stations seal. In either instance, these stations apply a heat seal up the side of the upper outer portion of the bag, so as to seal the first top end, second top end, edge of the re-sealable closure assembly and the gusset all together. The notch in the gusset, having been cut off at the one or more gusset punch stations, permits the front and second top end to be more securely sealed together than if the heat seal was to be applied through a complete gusset. Further, it is preferred that two left seal stations and two right seal stations be present, so that the strength of these seals is increased. Additionally, it is possible that only one left seal station and only one right seal station be present, but that each station applies a seal twice. In this manner, the assembly line may include, in order, a left seal station, a right seal station, a second left seal station, and a second right seal station. FIG. 9 shows a bag that has been sealed at one or more left seal stations and one or more right seal stations, the location of the heat seals shown by dashed lines.

In an embodiment, the area of each heat seal applied at the one or more left seal stations and the one or more right seal stations as indicated in FIG. 9 is 100 mm×20 mm. In this embodiment, each heat seal is effectuated through a heat seal bar, where each bar is separated from the bag by a loose Teflon sheet. In this embodiment, the heat seal bar may dwell on each bag for a period of between 0.7 seconds to 1.0 seconds, preferably 0.9 seconds. In this embodiment, the heat seal bar is at a temperature of between 350 degrees Fahrenheit to 450 degrees Fahrenheit, preferably 400 degrees Fahrenheit.

Optionally, the assembly line further comprises one or more cooling stations, where the cooling stations cool the heat seals that were applied at the one or more left seal stations and one or more right seal stations. Preferably, a cooling station comprises a cavity inside a bar, where chilled water may be run through the cavity, and the bar may be closed onto the portion of the bag that has been previously heat sealed at another station on the machine.

Optionally, the assembly line further comprises one or more excess assembly punch stations, where the outer upper portions of the bag are trimmed along the edge of the bag, such that no multi-layered paper composite is removed, but any excess re-sealable closure assembly that may have melted as a result of the heat seals applied at any of the various sealing stations and escaped the outermost edges of the bag is trimmed so as to provide a substantially clean, straight edge along the upper portion of the bag.

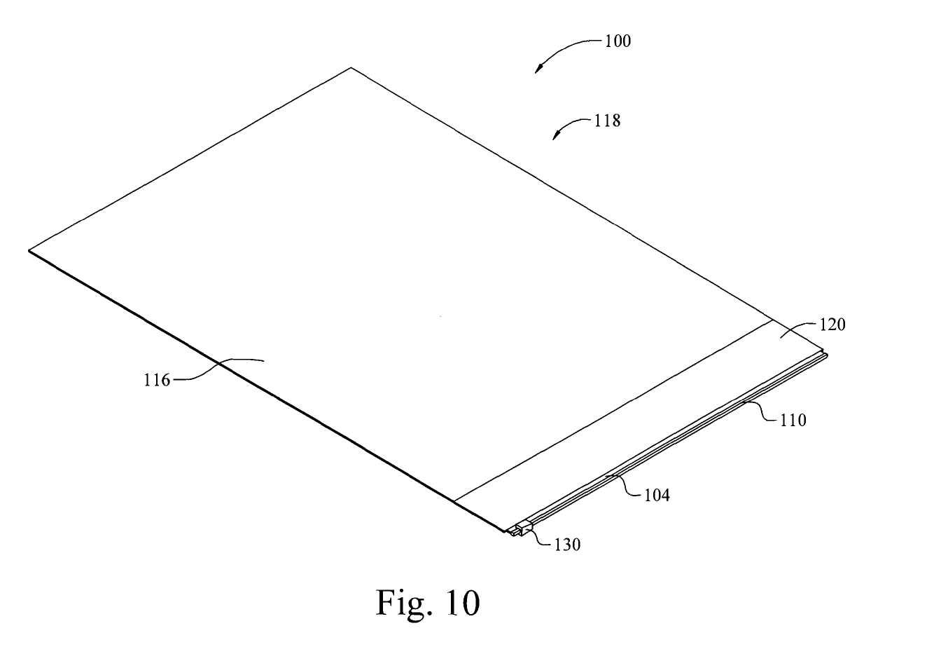

Finally, an optional first top end seal station may be present, this optional first top end seal station providing a heat seal across the entire width of the bag, applied across the first top end, this seal preferably being in substantial alignment with the seals applied at the re-sealable closure assembly introduction and seal station and the second top end seal station, and this heat seal sealing the first top end to the second top end, the gussets and the re-sealable closure assembly segment, thereby closing the top of the bag. The use of the optional first top end seal station would be determined by the desired one of two preferred embodiments of a finished product of the present invention, as further detailed below. FIG. 10 shows a completed multilayered paper composite bag of the present invention, this figure showing the gussets folded and the bag substantially flat.

In an embodiment, heat seal applied at the optional first top end seal station would be substantially similar to that applied at the second top end seal station as indicated in FIG. 7, except that the seal would be applied across the first top end. Thus, the heat seal applied at the optional first top end seal station area is 510 mm×10 mm. In this embodiment, the heat seal is effectuated through a heat seal bar, where the bar has a Teflon coating that covers the surface of the bar that contacts the bag. In this embodiment, the heat seal bar may dwell on each bag for a period of between 0.7 seconds to 3.0 seconds. In this embodiment, the heat seal clamp is at a temperature of between 400 degrees Fahrenheit to 500 degrees Fahrenheit.

Finally, two preferred embodiments of a finished product may be produced, those being the open bottom bag and the closed bottom bag, depending on which unfinished bag was used to make the finished product of the present invention. In either embodiment, the manufacturer of the bag of the present invention may create a bag that can be custom filled to the specifications of the food manufacturer, for example. Such flexibility increases the commercial value of the bag of the present invention.

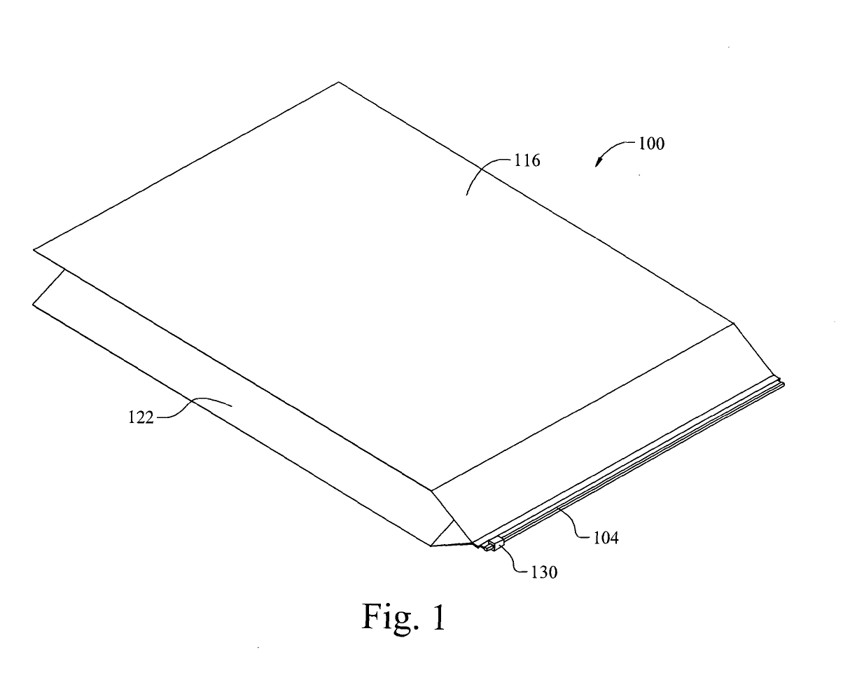

In the open bottom bag embodiment, an additional heat seal is provided to the outside of the first top end of the multi-layered paper bag at the optional first top end seal station. In such an embodiment, the food manufacturer, for example, would fill the bag with consumables from the bottom of the bag, and then close and seal the bag by any conventional means. The food manufacturer may employ a fold-and-seal type closure, where a step cut bottom of the bag is folded such that the dominantly protruding portion of the base of the bag is folded over the least protruding portion of the base of the bag, and optionally hot glue melt or similar material is present, and, upon the application of pressure and optional heat, the base of the bag is sealed. The food manufacturer may alternatively employ a pinch-and-seal type closure, where a flush cut bottom of the bag is pinched and heat sealed, thereby sealing the base of the bag with the consumables inside. FIG. 1 is a perspective view of a first embodiment of the multilayered paper composite bag of the present invention, this figure showing the partially unfolded gussets, this embodiment including a bag that has been sealed by a first top end seal station.

In the closed bottom bag embodiment, the base of the bag has already been sealed, and no additional heat seal is provided to the outside of the front upper flap of the multi-layered paper bag at the optional first top end seal station, resulting in an incomplete seal between the first top end and the remainder of the bag. In such an embodiment, the food manufacturer, for example, would fill the bag with consumables from the top of the bag, between the innermost layer of the first top end of the multi-layered paper bag and the re-sealable closure assembly, and then close and seal the bag by providing an additional heat seal to the outside of the first top end in a manner similar to that provided by the optional first top end seal station.

FIG. 10 is a perspective view of a completed first embodiment of the multilayered paper composite bag of the present invention, this figure showing the gussets folded and the bag substantially flat.

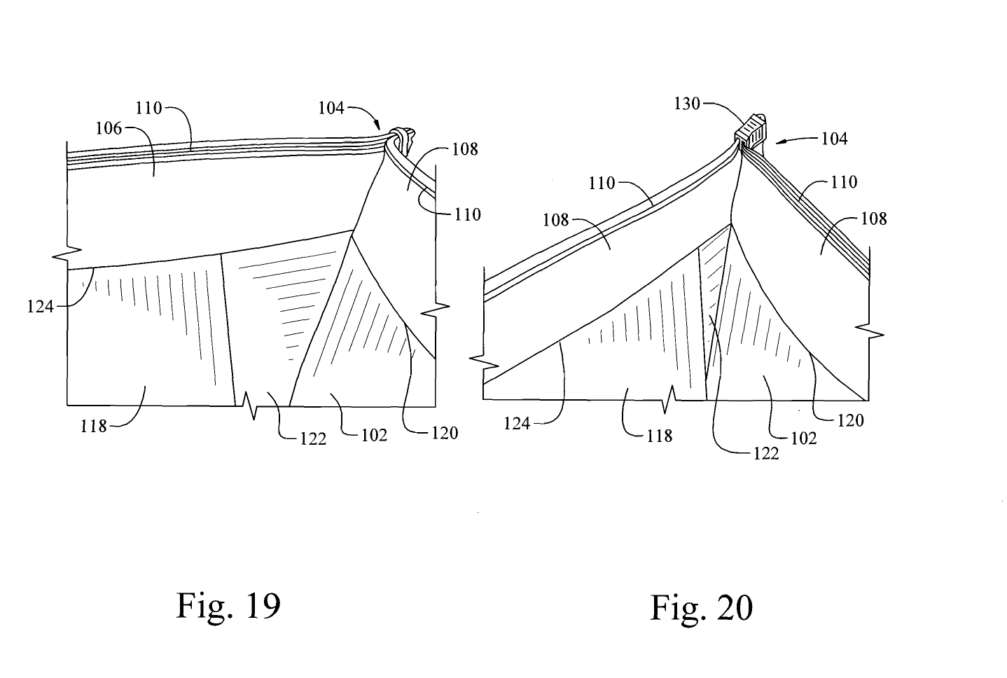

As can be seen in FIG. 19 and FIG. 20, the first embodiment of the multi-layered paper composite bag 100 of the present invention thus comprises both a multi-layered composite material 102 and a re-sealable closure assembly 104. The re-sealable closure assembly comprises a first ribbon 106 and a second ribbon 108, each ribbon comprising an interlocking profile 110, such that the interlocking profiles are complimentary in shape. The composite material 102 comprises an inner layer 112, a middle layer 114, and an outer layer 116. The composite material 102 has been formed into a gusseted bag 118, with the inner layer 112 defining the inside of the bag and the outer layer 116 defining the outside of the bag. The bag comprises a first top end 120, two gussets 122 and a second top end 124, the first top end and the second top end having flush upper edges 126. The re-sealable closure assembly 104 is attached to the gusseted bag 118 such that the interlocking profiles 110 are above and substantially parallel to the flush upper edges 126 of the first top end 120 and the second top end 124 and the first ribbon 106 is attached to the inner layer 112 of the bag by at least one heat seal running the length of the first ribbon from one gusset 122 across the second top end 124 to the other gusset 122. The gussets 122 each further comprise a notch 128, and the first top end 120 and the second top end 124 have been attached to one another by at least one heat seal through each notch. Such a bag may be a closed bottom bag. Further, the re-sealable closure assembly may further comprise a slider 130 operably mounted thereon, as well as a tamper-evident membrane 132. Preferably, the outer layer 116 is clay coated paper, the middle layer 114 is Kraft paper, and the inner layer 112 is selected from the group consisting of co-extruded polyethylene and polyethylene blend.

The first embodiment may additionally include a bag where the second ribbon 108 of the re-sealable closure assembly is attached to the inner layer 112 of the bag by at least one heat seal running the length of the second ribbon across the first top end 120. Such a bag may be an open bottom bag. Further, the re-sealable closure assembly may further comprise a slider 130 operably mounted thereon, as well as a tamper-evident membrane 132.

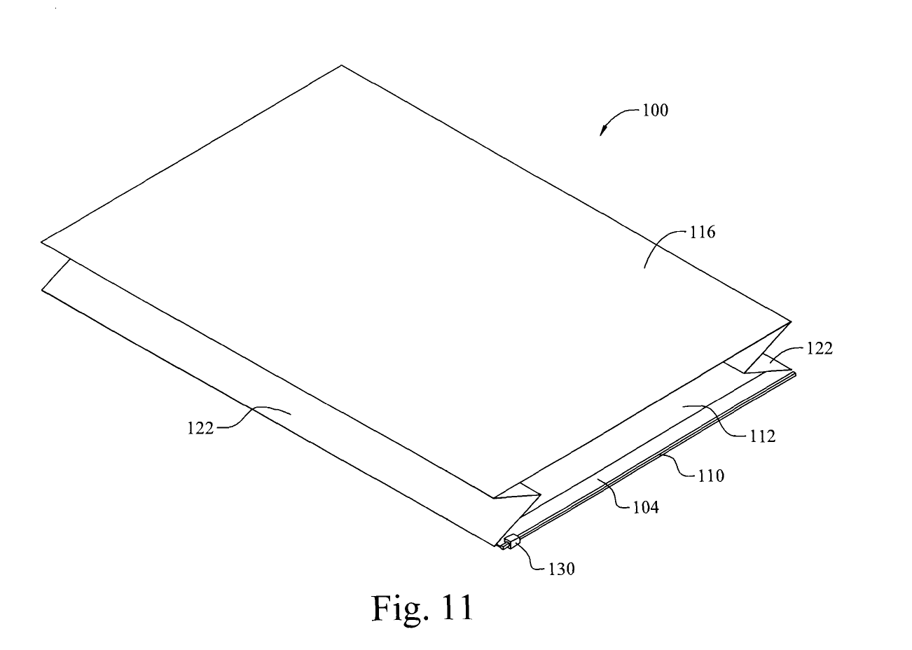

A second embodiment of a closed bottom bag may also be manufactured, as can be seen generally in FIG. 11 through FIG. 18, this embodiment being the wide mouth top fill bag. FIG. 11 is a perspective view of the wide mouth top fill bag, this figure showing the partially unfolded gussets, though this particular view includes an unsealed flush cut bottom so as to show the detail of the open gussets.

To manufacture a wide mouth top fill bag, an unfinished closed bottom bag detailed previously herein is undergoes a machine-driven assembly line type manufacturing process that attaches the spool-fed zipper strip material.

Preferably, the stations, in sequential order from the magazine or other suitable type of holding location or device to the opposing termination of the conveyor belt or similar device, comprise a bag introduction station, a bag cutting station, a bag opening station, a re-sealable closure assembly feeder station, a re-sealable closure assembly introduction and seal station, a second top end seal station, one or more left seal stations, one or more right seal stations, one or more optional cooling stations, and one or more optional excess assembly punch stations. It is highly preferred that a control station with a control logic also be present.

The bag introduction station non-destructively places the unfinished bag onto the assembly line, preferably onto a conveyor belt or bed or other similar conveyable surface or surfaces.

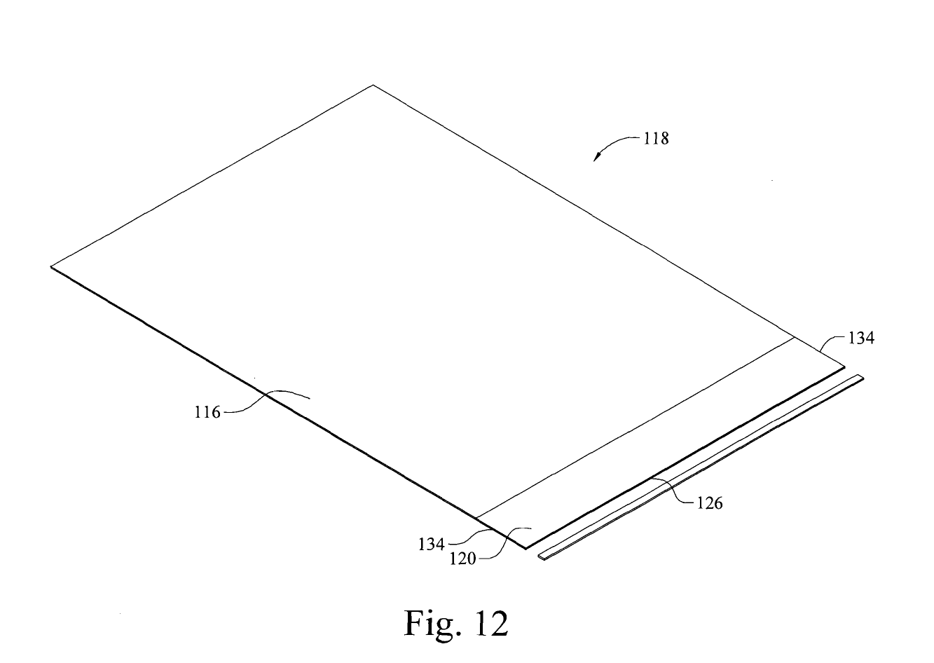

The bag cutting station cuts a strip of multi-layered paper composite material from the top of the bag in a flush cut, this flush cut being sufficient so as to remove the top portion of the bag from just below the top of the slits, this flush cut creating a first top end and a second top end and upper portions of the gussets, and thereby partially separating the front and second top end from the corresponding upper portions of the gussets. FIG. 12 shows a bag that has been trimmed at a bag cutting station.

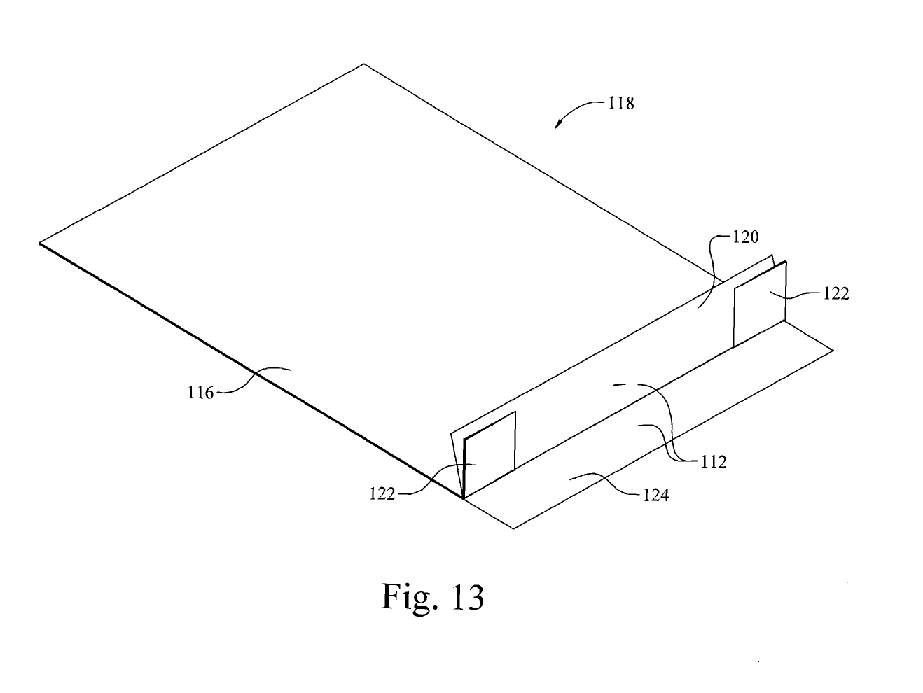

The bag opening station non-destructively folds the first top end and the gussets away from the second top end, thereby exposing the second top end, which remains substantially horizontal with respect to the conveyor belt. FIG. 13 shows a bag that has had its first top end and gussets folded at the bag opening station.

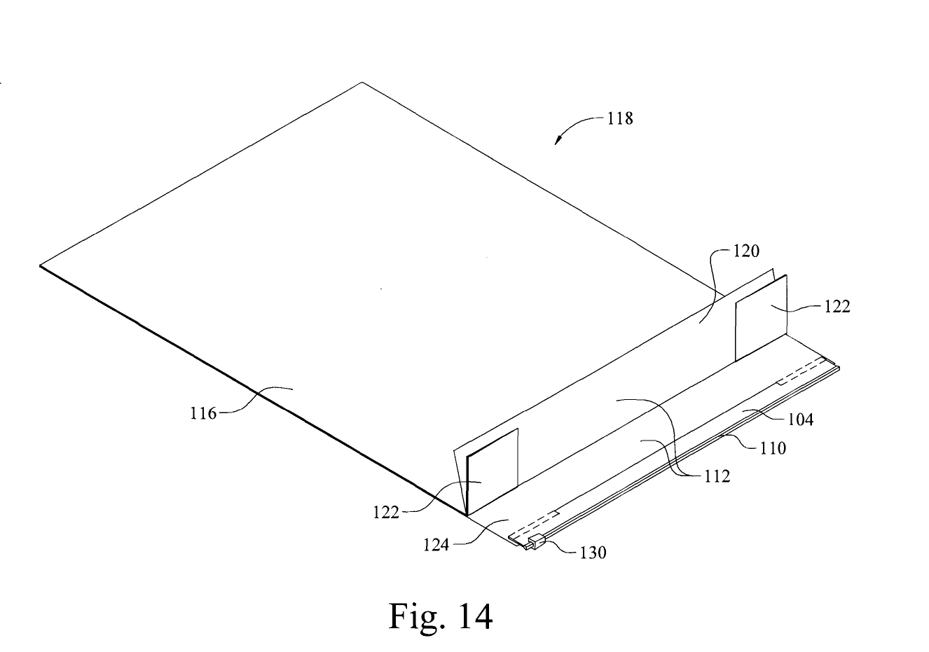

Once the first top end and gussets have been folded at the bag opening station, the re-sealable closure assembly introduction and seal station, for each bag, then introduces a single bag re-sealable closure assembly to the upper portion of the exposed second top end, such that the re-sealable closure assembly is substantially centered between the edges of the second top end. Having introduced a single re-sealable closure assembly to a bag, the re-sealable closure assembly introduction and seal station then heat seals the segment to two upper portions of the second top end. FIG. 14 shows a bag that has had the re-sealable closure assembly introduced thereto and has further had two heat seals applied, the location of the heat seals shown by dashed lines.

In an embodiment, the area of each heat seal applied at the re-sealable closure assembly introduction and seal station as indicated in FIG. 14 is 60 mm×10 mm. In this embodiment, each heat seal is effectuated through a heat seal clamp, where each clamp has a Teflon coating that covers the surface of the clamp that contacts the bag. In this embodiment, the heat seal clamp may dwell on each bag for a period of between 0.7 seconds to 1.5 seconds, preferably 0.9 seconds. In this embodiment, the heat seal clamp is at a temperature of between 500 degrees Fahrenheit to 600 degrees Fahrenheit, preferably 554 degrees Fahrenheit.

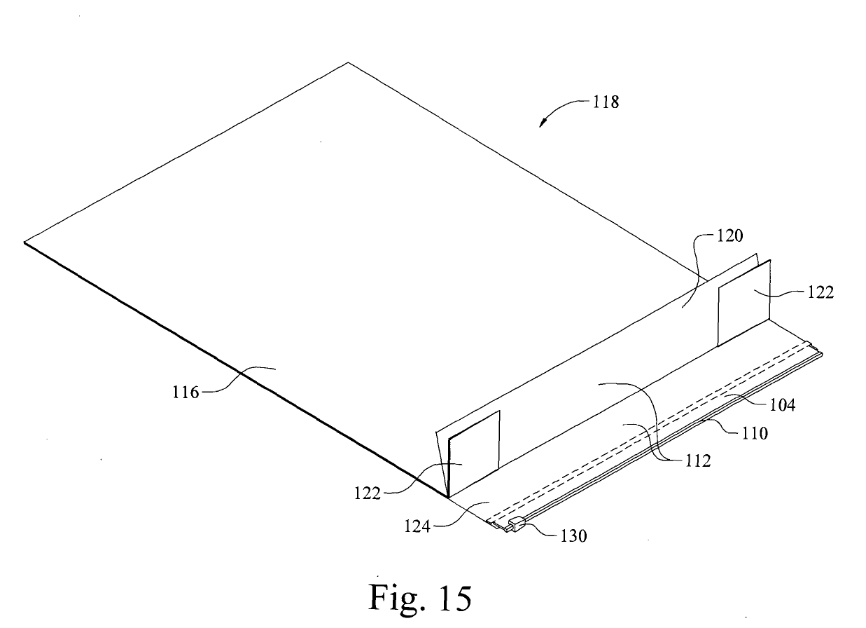

The second top end seal station applies a heat seal across the entire width of the bag, this seal preferably being in substantial alignment with the seals applied at the re-sealable closure assembly introduction and seal station. FIG. 15 shows a bag that has been sealed at the second top end seal station, the location of the heat seal shown by dashed lines.

In an embodiment, the area of the heat seal applied at the second top end seal station as indicated in FIG. 15 is 510 mm×10 mm. In this embodiment, the heat seal is effectuated through a heat seal bar, where the bar has a Teflon coating that covers the surface of the bar that contacts the bag. In this embodiment, the heat seal bar may dwell on each bag for a period of between 0.7 seconds to 3.0 seconds. In this embodiment, the heat seal clamp is at a temperature of between 400 degrees Fahrenheit to 500 degrees Fahrenheit.

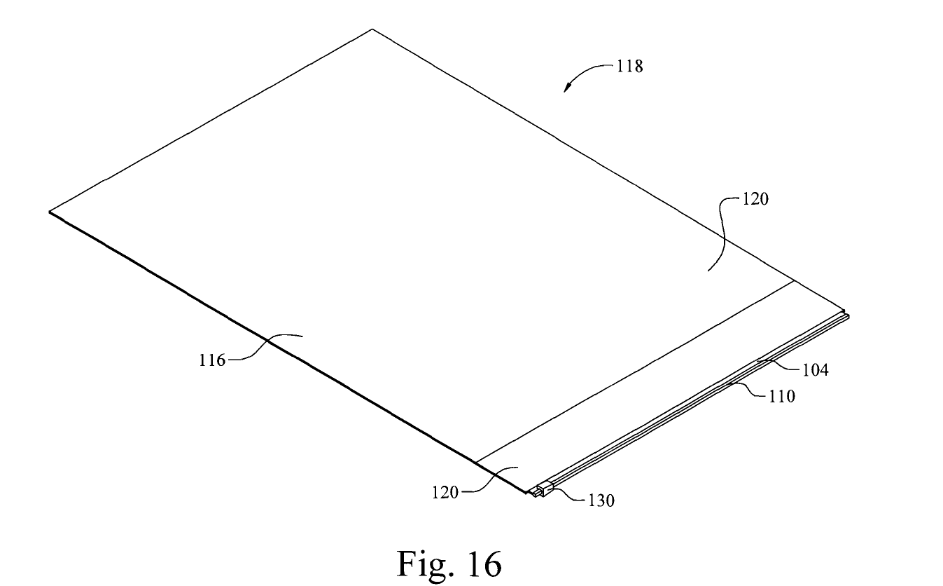

Once the bag has passed the second top end seal station, the first top end and gussets is re-folded back into substantially parallel alignment with the remainder of the bag, which can be achieved through any number of mechanical devices known to those of ordinary skill in the art, including a stationary, non-mechanical curved rod positioned so as to non-destructively manipulate the first top end as the bag moves down the assembly line on the conveyor belt. FIG. 16 shows a bag that has had the first top end and gussets re-folded back into alignment with the remainder of the bag.

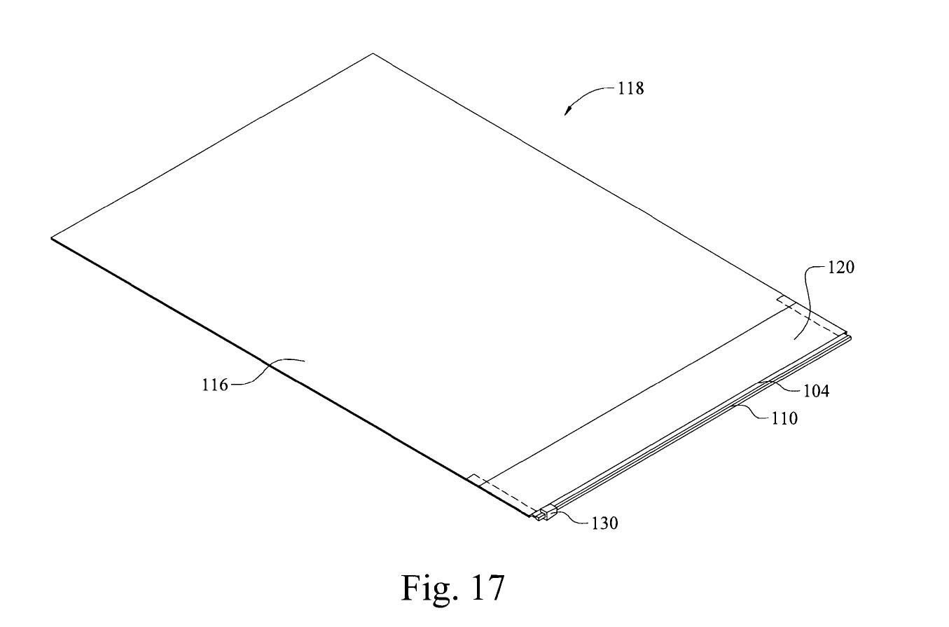

The one or more left seal stations and the one or more right seal stations have similar functions and purposes, the distinctions between the right seal station and the left seal station being the side of the bag that the respective stations seal. In either instance, these stations apply a heat seal up the side of the upper outer portion of the bag, so as to seal the first top end to the gusset, the second top end and the edge of the re-sealable to the gusset, but not seal the gusset to itself. In an embodiment, two left seal stations and two right seal stations are present, so that the strength of these seals is increased. Additionally, it is possible that only one left seal station and only one right seal station be present, but that each station applies a seal twice. In this manner, the assembly line may include, in order, a left seal station, a right seal station, a second left seal station, and a second right seal station. FIG. 17 shows a bag that has been sealed at one or more left seal stations and one or more right seal stations, the location of the heat seals shown by dashed lines.

In an embodiment, the area of each heat seal applied at the one or more left seal stations and the one or more right seal stations as indicated in FIG. 17 is 100 mm×20 mm. In this embodiment, each heat seal is effectuated through a heat seal bar, where each bar is separated from the bag by a loose Teflon sheet. In this embodiment, the heat seal bar may dwell on each bag for a period of between 0.7 seconds to 1.0 seconds, preferably 0.9 seconds. In this embodiment, the heat seal bar is at a temperature of between 350 degrees Fahrenheit to 450 degrees Fahrenheit, preferably 400 degrees Fahrenheit.

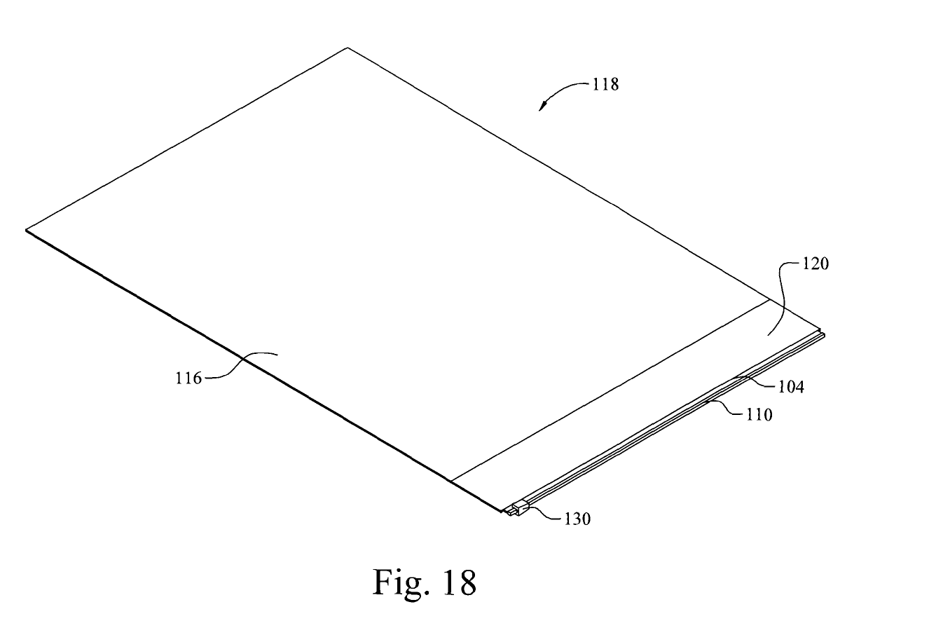

FIG. 18 is a perspective view of a completed wide mouth top fill bag embodiment of the present invention, this figure showing the gussets folded and the bag substantially flat.

Optionally, the assembly line further comprises one or more cooling stations, where the cooling stations cool the heat seals that were applied at the one or more left seal stations and one or more right seal stations. Optionally, the assembly line further comprises one or more excess assembly punch stations.

The second embodiment of the multi-layered paper composite bag 100 of the present invention thus comprises both a multi-layered composite material 102 and a re-sealable closure assembly 104. The re-sealable closure assembly 104 comprises a first ribbon 106 and a second ribbon 108, each ribbon comprising an interlocking profile 110, such that the interlocking profiles are complimentary in shape. The composite material 102 comprises an inner layer 112, a middle layer 114, and an outer layer 116. The composite material 102 has been formed into a gusseted bag 118, with the inner layer 112 defining the inside of the bag and the outer layer 116 defining the outside of the bag. The bag comprises a first top end 120, two gussets 122 and a second top end 124, the first top end and the second top end having flush upper edges 126. The re-sealable closure assembly 104 is attached to the gusseted bag 118 such that the interlocking profiles 110 are above and substantially parallel to the flush upper edges 126 of the first top end 120 and the second top end 124 and the first ribbon 106 is attached to the inner layer 112 of the bag by at least one heat seal running the length of the first ribbon 106 across the second top end 124. Such a bag is a closed bottom bag. Further, the re-sealable closure assembly 104 may further comprise a slider 130 operably mounted thereon, as well as a tamper-evident membrane 132. Preferably, the outer layer 116 is clay coated paper, the middle layer 114 is Kraft paper, and the inner layer 112 is selected from the group consisting of co-extruded polyethylene and polyethylene blend.

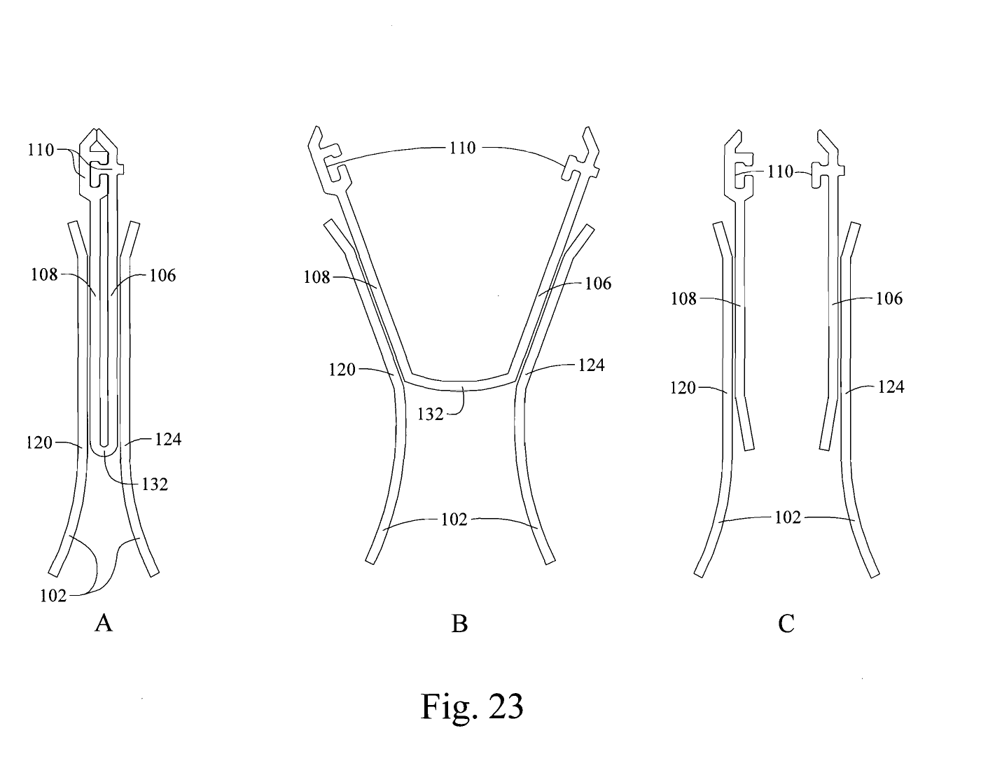

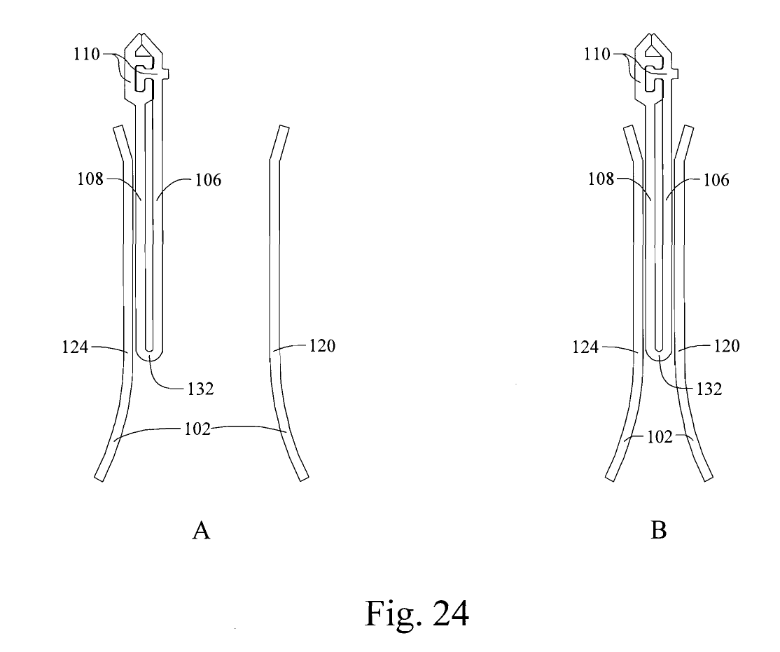

One advantage to the bags of the present invention is the ability of the bag manufacturer to include the highly-desirable feature of a tamper-evident re-sealable closure assembly, regardless of whether the finished product is an open bottom bag or a closed bottom bag. For example, FIG. 23A is a cross-sectional view of a suitable tamper-evident re-sealable closure assembly, such as one that may be mounted inside a closed-bottom bag, this figure showing the tamper-evident membrane intact and the re-sealable closure assembly closed. FIG. 23B shows the same tamper-evident membrane intact and the re-sealable closure assembly open. Finally, FIG. 23C shows the same tamper-evident membrane open and the re-sealable closure assembly open. In another example, FIG. 24A is a cross-sectional view of a suitable tamper-evident re-sealable closure assembly, such as one that may be mounted inside an open-bottom bag, this figure showing the tamper-evident membrane intact and the re-sealable closure assembly closed, and further showing the opening through which bag contents may be inserted. FIG. 24B shows the same tamper-evident re-sealable closure assembly, where the tamper-evident membrane intact and the re-sealable closure assembly closed, and further showing the closure of the opening through which bag contents may be inserted. It should be noted that the aforementioned FIGS. 23A-24B depict the multi-layer composite material as one layer so as to emphasize the relationship between the re-sealable closure assembly and the multi-layer composite material.

The present invention additionally includes a method of making a multi-layered paper composite bag, such as the one detailed herein, through the introduction of an unfinished multilayered paper composite bag to a machine with the above-described stations so as to create any of: an open bottom bag, a closed bottom bag, and a wide mouth top fill bag.

The present invention additionally includes a product made by the method of making a multi-layered paper composite bag, such as the one detailed herein.

As used herein, the term “mass-produced” refers to a plurality of products manufactured on a scale greater than that of an individual laborer, more preferably to a machine-driven assembly line type manufacturing process. Indeed, one of ordinary skill in the art might be able to manufacture a multi-layered paper composite bag with a re-sealable closure assembly attached to the innermost layer of the bag on a single bag basis, with tools and materials known to those of skill in the art. Such a method is inefficient and not cost-effective. The novel method detailed herein by the inventors relates to the manufacture of such bags on a larger scale and overcomes the inefficiencies associated with such manufacture.

It should be understood that the aforementioned embodiments are for exemplary purposes only and are merely illustrative of the many possible specific embodiments that can represent applications of the principles of the invention.

Without departing from the spirit and scope of this invention, one of ordinary skill in the art can make various changes and modifications to the invention to adapt it to various usages and conditions, including those not specifically laid out herein. As such, those changes and modifications are properly, equitably, and intended to be, within the full range and scope of equivalents of the invention disclosed and described herein.

We claim:

1. A bag comprising:
a pair of panels of multi-layered composite material, each panel having opposite sides, and opposite top and bottom, the top terminating in a top edge, the top edges being generally parallel to each other, and a re-sealable closure assembly;
wherein the re-sealable closure assembly comprises a first ribbon and a second ribbon, each ribbon comprising an interlocking profile extending longitudinally along the ribbon, such that the interlocking profiles are complimentary in shape; and,
wherein each of the panels comprises an inner layer, a middle layer, and an outer layer; and
wherein the panels are interconnected at their sides by gussets of multi-layered composite material bridging the sides to form a gusseted bag having a closable top opening and a bottom that may be open or closed depending on whether or not the bottoms of the panels are interconnected, with the inner layer facing inwardly and the outer layers facing outwardly,
wherein the first ribbon of the re-sealable closure assembly is attached to the inner layer of the top of one panel from one side to the other and the second ribbon is attached or attachable to the inner layer of the top of the other panel from one side to the other such that the interlocking profiles are above and generally parallel to the top edges of the panels.

2. The bag of claim 1, wherein the gussets each further comprise a notch, and where the tops of each panel have been attached to one another by at least one heat seal through each notch.

3. The bag of claim 1, wherein the outer layer is clay coated paper, the middle layer is Kraft paper, and the inner layer is selected from the group consisting of co-extruded polyethylene and polyethylene blend.

4. The bag of claim 1, wherein the bag is a closed bottom bag.

5. The bag of claim 1, where the re-sealable closure assembly further comprises a tamper-evident membrane.

6. The multi-layered bag of claim 1, wherein the second ribbon of the re-sealable closure assembly is attached to the inner layer of the bag by at least one heat seal running the length of the second ribbon across the first top end.

7. The bag of claim 6, where the bag is an open bottom bag.

8. The bag of claim 6, where the re-sealable closure assembly further comprises a tamper-evident membrane.

9. An unfinished bag comprising:
a pair of panels of multi-layered composite material, each panel having opposite sides, and opposite top and bottom, the top terminating in a top edge, the top edges being generally parallel to each other;
wherein each of the panels comprises an inner layer, a middle layer, and an outer layer; and
wherein the panels are interconnected at their sides by gussets of multi-layered composite material bridging the sides to form a gusseted bag having a closable top opening and a bottom that may be open or closed depending on whether or not the bottoms of the panels are interconnected, with the inner layer facing inwardly and the outer layers facing outwardly,
where at the tops of the panels both of the gussets on each side of the bag comprise two folds that define the edges of the bag, each fold comprising a slit, each of the four slits generally identical to one another, each slit residing 5 mm to 10 mm below the top edge, each slit between 90 mm to 100 mm in length.

10. The unfinished bag of claim 9, wherein the outer layer is clay coated paper, the middle layer is Kraft paper, and the inner layer is selected from the group consisting of co-extruded polyethylene and polyethylene blend.

11. The unfinished bag of claim 10, wherein the unfinished bag comprises a closed bottom.

12. The unfinished bag of claim 10, wherein the unfinished bag comprises an open bottom.

13. A method of making a bag, comprising the steps of:
providing an unfinished bag, the unfinished bag comprising a pair of panels of multi-layered composite material, each panel having opposite sides, and opposite top and bottom, the top terminating in a top edge, the top edges being generally parallel to each other;
wherein each of the panels comprises an inner layer, a middle layer, and an outer layer; and
wherein the panels are interconnected at their sides by gussets of multi-layered composite material bridging the sides to form a gusseted bag having a closable top opening and a bottom that may be open or closed depending on whether or not the bottoms of the panels are interconnected, with the inner layer facing inwardly and the outer layers facing outwardly,
where at the tops of the panels both of the gussets on each side of the bag comprise two folds that define the edges of the bag, each fold comprising a slit, each of the four slits generally identical to one another and located at generally the same distance from the top edges; and
providing a re-sealable closure assembly, wherein the re-sealable closure assembly comprises a first ribbon and a second ribbon, each ribbon comprising an interlocking profile extending longitudinally along the ribbon, such that the interlocking profiles are complimentary in shape;
cutting the unfinished bag so as to remove a strip of multi-layered paper composite material from the top of the bag in a flush cut, this flush cut being sufficient so as to remove 5 mm to 10 mm of the top portion of the bag, this flush cut creating a first top end and a second top end and upper portions of the gussets, thus permitting the top end of each panel to be folded away from the upper portions of the gussets;
folding the top ends of each panel away from the upper portions of the gussets;
cutting a notch into each of the upper portions of the gussets;
folding the second top end into substantially parallel alignment with the upper portions of the gussets;
introducing the re-sealable closure assembly to the upper portion of the gussets and the second top end, such that the re-sealable closure assembly is substantially centered between the gussets, such that interlocking profiles reside above the top edge of the second top end,
applying a heat seal to the re-sealable closure assembly across the width of each gusset, substantially parallel to the length of the re-sealable closure assembly;
applying a heat seal longitudinally across the re-sealable closure assembly;
refolding the first top end into generally parallel alignment with the remainder of the bag;
applying at least one heat seal on each side of the first top end, so as to seal the first top end, the second top end, the re-sealable closure assembly and a gusset all together through each notch.

14. A method of making a bag, comprising the steps of:
providing an unfinished bag, the unfinished bag comprising a pair of panels of multi-layered composite material, each panel having opposite sides, and opposite top and bottom, the top terminating in a top edge, the top edges being generally parallel to each other;
wherein each of the panels comprises an inner layer, a middle layer, and an outer layer; and
wherein the panels are interconnected at their sides by gussets of multi-layered composite material bridging the sides to form a gusseted bag having a closable top opening and a bottom that may be open or closed depending on whether or not the bottoms of the panels are interconnected, with the inner layer facing inwardly and the outer layers facing outwardly,
where at the tops of the panels both of the gussets on each side of the bag comprise two folds that define the edges of the bag, each fold comprising a slit, each of the four slits generally identical to one another and located at generally the same distance from the top edges; and
providing a re-sealable closure assembly, wherein the re-sealable closure assembly comprises a first ribbon and a second ribbon, each ribbon comprising an interlocking profile extending longitudinally along the ribbon, such that the interlocking profiles are complimentary in shape;
cutting the unfinished bag so as to remove a strip of multi-layered paper composite material from the top of the bag in a flush cut, this flush cut being sufficient so as to remove 5 mm to 10 mm of the top portion of the bag, this flush cut creating a first top end and a second top end and upper portions of the gussets, thus permitting the top end of each panel to be folded away from the upper portions of the gussets;
folding the first top end and the upper portions of the gussets away from the second top end;
introducing the re-sealable closure assembly to the second top end, such that the re-sealable closure assembly is substantially centered longitudinally on the second top end, such that interlocking profiles reside above the top edge of the second top end,
applying two heat seals to the re-sealable closure assembly segment across the second top end, aligned linearly with each other and generally parallel to the length of the re-sealable closure assembly segment;
applying a heat seal across the entire width of the re-sealable closure assembly segment;
refolding the first top end and the upper portions of the gussets back into substantially parallel alignment with the remainder of the bag;
applying at least one heat seal on each side of the first top end, so as to seal the first top end to the upper portion of the gusset, and the second top end, the re-sealable closure assembly and the upper portion of the gusset all together.
